(19) United States
(12) Patent Application Publication
(10) Pub. No.: US 2009/0190545 A1
(43) Pub. Date: Jul. 30, 2009

(54) BROADBAND WIRELESS ACCESS SYSTEM, BASE STATION, AND NOTIFICATION METHOD BY THE BASE STATION

(75) Inventor: Keiichi Kubota, Tokyo (JP)

Correspondence Address: DICKSTEIN SHAPIRO LLP, 1177 AVENUE OF THE AMERICAS (6TH AVENUE), NEW YORK, NY, 10036-2714, US

(73) Assignee: NEC Corporation, Tokyo (JP)

(21) Appl. No.: 12/361,245

(22) Filed: Jan. 28, 2009

(30) Foreign Application Priority Data
Jan. 30, 2008 (JP) 2008-019185

(51) Int. Cl. H04W 74/00

(52) U.S. Cl. 370/329

(57) ABSTRACT

A base station includes a resources examination requesting unit that, when the base station is requested by a terminal to perform any of the following operations including addition, creation and change of a service flow, inquires of a radio resources management node whether the base station has enough radio resources to perform the operation on the service flow requested by the terminal; and a terminal notification unit that, when the base station lacks the radio resources, notifies the terminal of a base station that is selected from among neighboring base stations by the radio resources management node as a performer base station for performing the operation on the service flow requested by the terminal. The radio resources management node includes a resources examination responding unit that, when the requested target base station lacks the radio resources, selects a base station with enough radio resources to perform the operation on the service flow requested by the terminal from among the neighboring base stations as the performer base station.

This application is based upon and claims the benefit of priority from Japanese patent application No. 2008-019185, filed on Jan. 30, 2008, the disclosure of which is incorporated herein in its entirety by reference.

### BACKGROUND OF THE INVENTION

1. Field of the Invention

The present invention relates to Fixed and Mobile Broadband Wireless Access Systems (WiMAX; Worldwide Interoperability for Microwave Access), a base station, and a notification method by the base station.

2. Description of the Related Art

Broadband wireless access systems are defined in IEEE 802.16 series of standards and in WiMAX Forum.

In broadband wireless access systems, a service flow is dynamically added for transmitting and receiving user data between a terminal (Subscribe Station/Mobile Station, SS/MS) and an access service network (ASN) in some cases (National Publication of International Patent Application No. 2007-525925).

According to IEEE 802.16 series specifications and WiMAX Forum specifications, in a dynamic service flow addition procedure, when a terminal requests an access service network to dynamically add a service flow, a requested target base station (BS) in the access service network adds a new service flow. It should be noted that in this patent specification, the term “Base Station” includes the sector of the Base Station.

In some cases, however, when the terminal requests to dynamically add the service flow, the requested target base station has to give up adding a new service flow owing to its radio resources shortage. That problem will be described below with reference to FIG. 1.

The broadband wireless access system shown in FIG. 1 has terminal (SS/MS) 30; and access service network (ASN) 40 that provides all the network functions required for wireless access for terminal 30.

Access service network 40 includes base stations (BSs) 41A and 41B, each of which is a logical node implementing WiMAX MAC (Media Access Control) or PHY (Physical Layer) compliant with the IEEE 802.16 series; and radio resources management node 42, which is a logical node for managing the radio resources of base stations 41A and 41B.

The broadband wireless access system shown in FIG. 1 has a platform, in which two base stations 41A and 41B support the same radio coverage to overlay the same geographical area, in preparation for load distribution and radio capacity increasing.

Referring to FIG. 1, at step 501, terminal 30 performs an entry operation into the WiMAX network through base station 41A. At this moment, base station 41A is unable to accept addition of a new service flow owing to its radio resources shortage.

At step 502, terminal 30 requests base station 41A to dynamically add a service flow.

As base station 41A, however, is in a congested state, base station 41A returns a rejection response against the service flow addition request to terminal 30 at step 503.

At this moment, base station 41B, which covers the same geographical area as base station 41A, can add the service flow, as base station 41B is in a non-congested state with enough radio resources to add a service flow.

As base station 41A cannot notify terminal 30 that base station 41B can add the service flow, base station 41A cannot redirect the connection of terminal 30 toward base station 41B. As the result, the new service flow addition ends in failure.

Even if terminal 30 performs a handover operation to redirect the connection toward base station 41B, since base station 41A does not make the above-described notification to terminal 30, the new service flow cannot be added until the user of terminal 30 actively issues the service flow addition request again.

That is, broadband wireless access systems have a problem in that the systems cannot effectively make use of the radio resources of base stations even when the platform for making a plurality of base stations overlay the same geographical area in preparation for load distribution and radio capacity increase.

### SUMMARY OF THE INVENTION

An object of the present invention is to provide a broadband wireless access system, a base station, and a notification method by the base station that solves the above-described problem.

The broadband wireless access system of the present invention is a broadband wireless access system comprising a terminal; and an access service network including a base station and a radio resources management node for managing radio resources of the base station,

wherein said base station comprises:
a resources examination requesting unit that, when said base station is requested by said terminal to perform any of the following operations including addition, creation and change of the service flow, inquires of said radio resources management node whether said base station has enough radio resources to perform the requested operation on the service flow; and
a terminal notification unit that, when said base station lacks the radio resources, notifies said terminal of a base station that is selected from among neighboring base stations by said radio resources management node as a performer base station for performing the requested operation on the service flow; and

said radio resources management node comprises:
a resources examination responding unit that, when the requested target base station lacks the radio resources, selects a base station having enough radio resources to perform the requested operation on the service flow from among the neighboring base stations as said performer base station.

The base station according to the present invention is a base station provided in an access service network of a broadband wireless access system, comprising:

a resources examination requesting unit that, when said base station is requested by a terminal to perform any of the following operations including addition, creation and change of the service flow, inquires of a radio resources management node whether the base station has enough radio resources to perform the requested operation on the service flow; and

a terminal notification unit that, when the base station lacks the radio resources, notifies the terminal of a base station that is selected from among neighboring base stations by the radio resources management node as a performer base station for performing the requested operation on the service flow.

The notification method according to the present invention is a base station notification method by a base station provided in an access service network of a broadband wireless access system, comprising:

inquiring of a radio resources management node whether the base station has enough radio resources to perform a requested operation on a service flow, when any of the following operations including addition, creation and change of the service flow is requested by a terminal; and

notifying the terminal of a base station that is selected from among neighboring base stations by the radio resources management node as a performer base station for performing the requested operation on the service flow, when the base station lacks the radio resources.

According to the present invention, when the terminal requests the base station to perform addition, creation or change of the service flow but the requested target base station lacks the radio resources, the access service network notifies the terminal of a base station from among neighboring base stations that has enough radio resources to perform the operation on the service flow requested by the terminal.

Accordingly, the present invention has the advantage of effectively making use of the radio resources of the base stations in the access service network.

The above and other objects, features, and advantages of the present invention will become apparent from the following description with reference to the accompanying drawings which illustrate examples of the present invention.

### BRIEF DESCRIPTION OF THE DRAWINGS

FIG. 1 is a diagram showing outlined operations of a related broadband wireless access system;

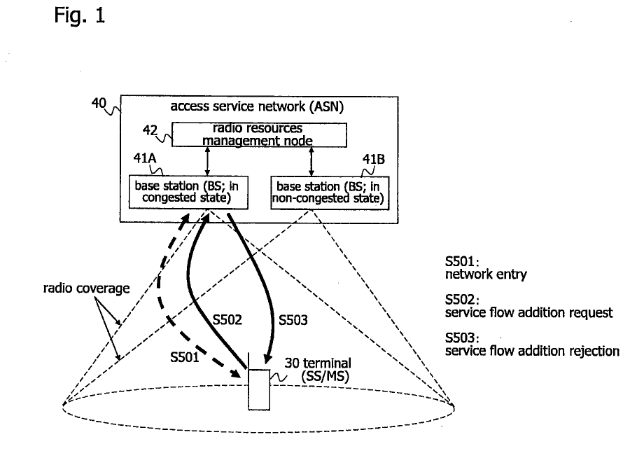

FIG. 2 is a block diagram showing an arrangement of broadband wireless access systems according to first and second exemplary embodiments;

FIG. 3 is a diagram showing outlined operations of the broadband wireless access system according to the first exemplary embodiment;

FIG. 4 is a sequence diagram showing detailed operations of the broadband wireless access system according to the first exemplary embodiment; and

FIG. 5 is a sequence diagram showing detailed operations of the broadband wireless access system according to the second exemplary embodiment.

### DESCRIPTION OF THE PREFERRED EMBODIMENTS

The preferred exemplary embodiments for implementing the present invention will be described below with reference to the drawings.

### First Exemplary Embodiment

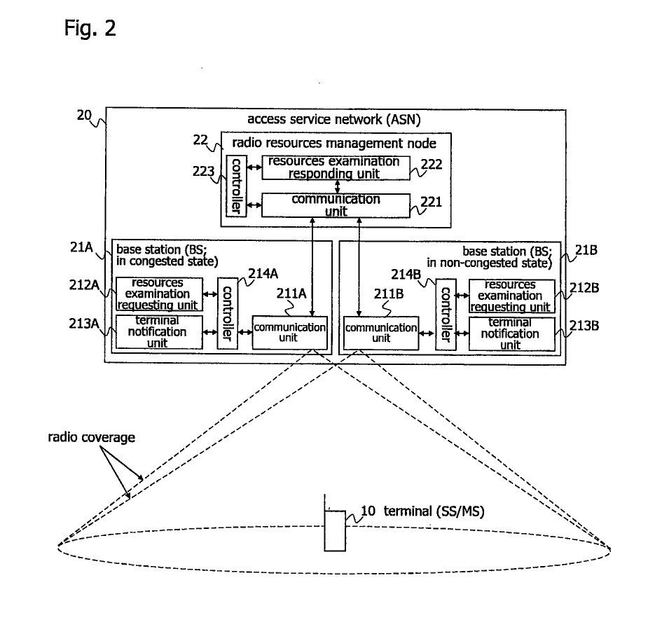

First, the arrangement of the broadband wireless access system of the exemplary embodiment will be described with reference to FIG. 2.

Referring to FIG. 2, the broadband wireless access system of the exemplary embodiment has terminal (SS/MS) 10; and access service network (ASN) 20 that provides a complete network function required for wireless access for terminal 10.

Access service network 20 includes base stations (BSs) 21A and 21B, each of which is a logical node implementing WiMAX MAC or PHY compliant with IEEE 802.16 series; and radio resources management node 22, which is a logical node for managing the radio resources of base stations 21A and 21B.

The broadband wireless access system of the exemplary embodiment has a platform, in which two base stations 21A and 21B support the same radio coverage to overlay the same geographical area, in preparation for load distribution and radio capacity increase.

Base station 21A has communication unit 211A, resources examination requesting unit 212A, terminal notification unit 213A, and controller 214A.

Communication unit 211A communicates with terminal 10 and radio resources management node 22.

When any of the following operations including addition, creation and change of the service flow is requested by terminal 10, resources examination requesting unit 212A inquires of radio resources management node 22 whether base station 21A has enough radio resources to perform the requested operation on the service flow.

When base station 21A has enough radio resources to perform the operation on the service flow requested by terminal 10, terminal notification unit 213A notifies terminal 10 that base station 21A accepts the service flow operation request.

Consider that base station 21A lacks the radio resources. When radio resources management node 22 selects a base station as the performer base station of the service flow operation requested by terminal 10 from among the neighboring base stations, terminal notification unit 213A notifies terminal 10 of the selected base station.

Controller 214A has control over base station 21A.

Similar to base station 21A, base station 21B has communication unit 211B, resources examination requesting unit 212B, terminal notification unit 213B, and controller 214B.

Radio resources management node 22 has communication unit 221, resources examination responding unit 222, and controller 223.

Communication unit 221 communicates with base stations 21A and 21B.

Resources examination responding unit 222 manages usage of radio resources for each of base stations 21A and 21B.

Resources examination responding unit 222 determines whether the base station that is the request target of the operation on the service flow has enough radio resources to perform the requested operation on the service flow or not. When the base station lacks the radio resources, resources examination responding unit 222 selects a base station with enough radio resources to perform the operation on the service flow requested by terminal 10 from among the neighboring base stations as the above-described performer base station.

The operations of the broadband wireless access systems of the exemplary embodiment will be described below.

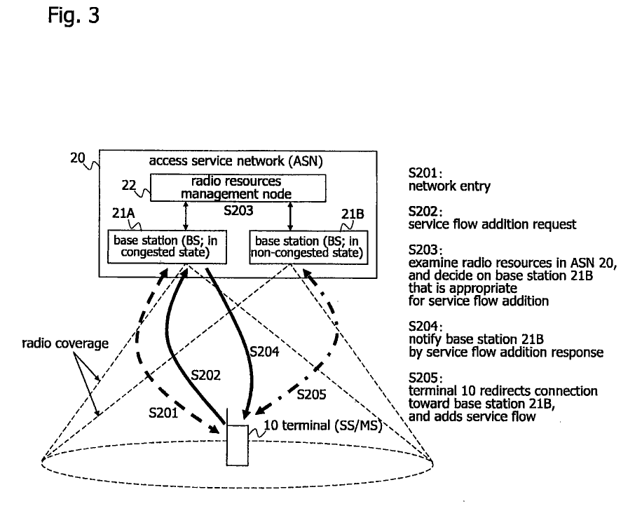

First, outlined operations of the broadband wireless access system according to the exemplary embodiment will be described with reference to FIG. 3. FIG. 3 shows operations in a dynamic service flow addition procedure.

Referring to FIG. 3, at step 201, terminal 10 performs the entry operation into the WiMAX network through base station 21A. At this moment, base station 21A is unable to accept addition of a new service flow owing to its radio resources shortage caused by congestion.

At step 202, terminal 10 requests base station 21A to dynamically add a service flow. In response, resources examination requesting unit 212A of base station 21A inquires of radio resources management node 22 whether base station 21A has enough radio resources to add the service flow.

Base station 21A, however, is in a congested state. Accordingly, at step 203, resources examination responding unit 222 of radio resources management node 22 selects a base station that is in a non-congested state and that has enough radio resources to add a service flow from the base stations near base station 21A (including those not shown) as the base station to add the service flow. It is assumed that base station 21B is selected here.

At step 204, terminal notification unit 213A of base station 21A notifies terminal 10 of base station 21B selected at step 203 in response to the service flow addition request.

At step 205, terminal 10 redirects the connection toward base station 21B, which is notified at step 204, and adds a new service flow to base station 21B.

Accordingly, access service network 40 can effectively distribute radio resources among terminal 10. In that manner, the exemplary embodiment can effectively make use of the radio resources.

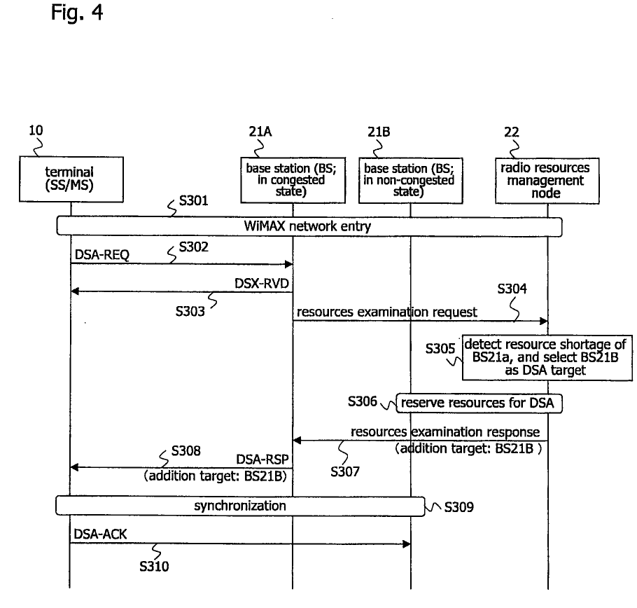

Now, detailed operations of the broadband wireless access system according to the exemplary embodiment will be described with reference to FIG. 4. FIG. 4 shows operations in the dynamic service flow addition procedure.

Referring to FIG. 4, at step 301, terminal 10 performs the entry operation into the WiMAX network through base station 21A.

At step 302, terminal 10 requests base station 21A by a dynamic service flow addition request message (DSA-REQ) to dynamically add a service flow for the purpose of transmitting and receiving user data.

At step 303, terminal notification unit 213A of base station 21A notifies terminal 10 through a request received message (DSX-RVD) that the dynamic service flow addition request message has been received.

At step 304, resources examination requesting unit 212A of base station 21A inquires of radio resources management node 22 in an arbitrary manner whether base station 21A has enough radio resources to add the service flow.

At step 305, resources examination responding unit 222 of radio resources management node 22 detects that base station 21A lacks the radio resources to add the service flow. Accordingly, resources examination responding unit 222 selects base station 21B, which is in a non-congested state and which has enough radio resources to add a service flow, from among the neighboring base stations as the base station to add the service flow.

At step 306, resources examination responding unit 222 of radio resources management node 22 reserves the radio resources for adding the service flow in base station 21B.

At step 307, resources examination responding unit 222 of radio resources management node 22 notifies base station 21A in an arbitrary manner that the addition target of the service flow is base station 21B.

At step 308, terminal notification unit 213A of base station 21A notifies terminal 10 that the addition target of the service flow is base station 21B by a dynamic service flow addition respond message (DSA-RSP).

At step 309, terminal 10 performs a necessary synchronizing operation with base station 21B, which is notified by a dynamic service flow addition respond message.

Then at step 310, terminal 10 notifies base station 21B to add the service flow by a dynamic service flow addition acknowledge message (DSA-ACK).

Although the operations in the dynamic service flow addition procedure are described in the exemplary embodiment, it is apparent that the same operations can be applied to the dynamic service flow creation procedure and the dynamic service flow change procedure.

As described above, when terminal 10 requests a base station to perform any of the following operations including addition, creation and change of the service flow but the requested target base station lacks the radio resources, access service network 20 notifies terminal 10 of the base station that has enough radio resources to perform the requested operation on the service flow in the exemplary embodiment.

Accordingly, the exemplary embodiment can effectively make use of the radio resources of the base stations in access service network 20 and increase the success rate of the service flow operation request from terminal 10.

### Second Exemplary Embodiment

The broadband wireless access system of the exemplary embodiment has the same arrangement as that of the first exemplary embodiment shown in FIG. 2 but provides operations different from those shown in FIG. 4.

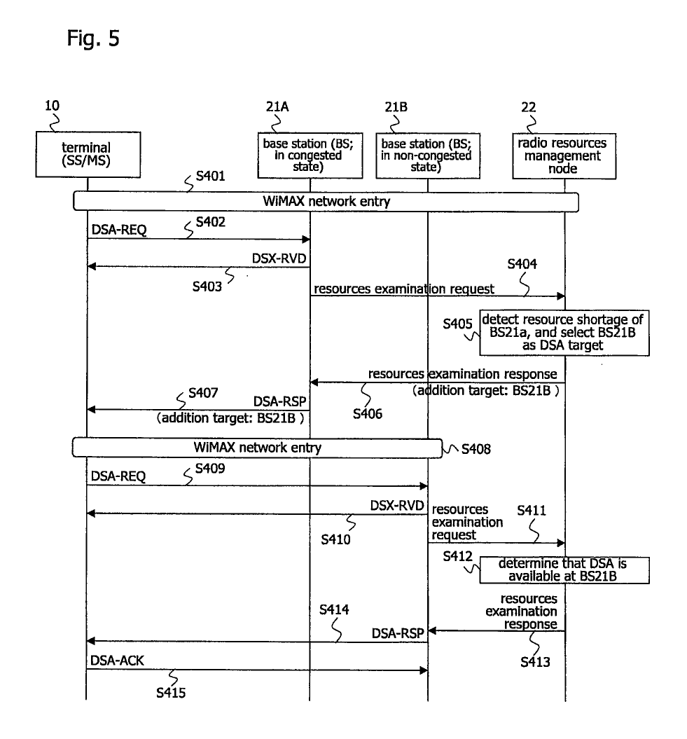

Detailed operations of the broadband wireless access systems of the exemplary embodiment will be described below with reference to FIG. 5. FIG. 5 shows operations in the dynamic service flow addition procedure.

Referring to FIG. 5, at step 401, terminal 10 performs the entry operation into the WiMAX network through base station 21A.

At step 402, terminal 10 requests base station 21A by the dynamic service flow addition request message (DSA-REQ) to dynamically add a service flow for the purpose of transmitting and receiving user data.

At step 403, terminal notification unit 213A of base station 21A notifies terminal 10 by the request received message (DSX-RVD) that the dynamic service flow addition request message has been received.

At step 404, resources examination requesting unit 212A of base station 21A inquires of radio resources management node 22 in an arbitrary manner whether base station 21A has enough radio resources to add the service flow.

At step 405, resources examination responding unit 222 of radio resources management node 22 detects that base station 21A lacks the radio resources to add the service flow. Accordingly, resources examination responding unit 222 selects base station 21B, which is in a non-congested state and which has enough radio resources to add a service flow, from among the neighboring base stations as the base station to add the service flow.

At step 406, resources examination responding unit 222 of radio resources management node 22 notifies base station 21A in an arbitrary manner that the addition target of the service flow is base station 21B.

At step 407, terminal notification unit 213A of base station 21A notifies terminal 10 that the addition target of the service flow is base station 21B by a dynamic service flow addition respond message (DSA-RSP).

At step 408, terminal 10 performs the entry operation into the WiMAX network through base station 21B, which is notified by a dynamic service flow addition respond message.

At step 409, terminal 10 requests base station 21B by a dynamic service flow addition request message (DSA-REQ) to dynamically add a service flow for the purpose of transmitting and receiving user data.

At step 410, terminal notification unit 213B of base station 21B notifies terminal 10 by the request received message (DSX-RVD) that the dynamic service flow addition request message is received.

At step 411, resources examination requesting unit 212B of base station 21B inquires of radio resources management node 22 in an arbitrary manner whether base station 21B has enough radio resources to add the service flow.

At step 412, resources examination responding unit 222 of radio resources management node 22 determines that base station 21B has enough radio resources to add the service flow and that base station 21B can add the service flow.

At step 413, resources examination responding unit 222 of radio resources management node 22 notifies base station 21B in an arbitrary manner that base station 21B has enough radio resources to accept the service flow addition request.

At step 414, terminal notification unit 213B of base station 21B notifies terminal 10 by a dynamic service flow addition respond message (DSA-RSP) that base station 21B accepts the service flow addition request.

Then at step 415, terminal 10 notifies base station 21B to add the service flow by a dynamic service flow addition acknowledge message (DSA-ACK).

Although operations in the dynamic service flow addition procedure are described in the exemplary embodiment, it is apparent that the same operations can be applied to the dynamic service flow creation procedure and to the dynamic service flow change procedure.

As described above, when terminal 10 requests a base station to perform any of the following operations including addition, creation and change of the service flow but the requested target base station lacks the radio resources, access service network 20 notifies terminal 10 of the base station that has enough radio resources to perform the requested operation on the service flow in the exemplary embodiment.

Accordingly, the exemplary embodiment can effectively make use of the radio resources of the base stations in access service network 20 and increase the success rate of the service flow operation request from terminal 10.

In the exemplary embodiment, since terminal 10 is adapted to perform the entry operation into the network through the base station that is notified as the performer base station of the service flow operation, the arrangement of access service network 20 does not need to be significantly changed from that of the first exemplary embodiment.

While the invention has been particularly shown and described with reference to exemplary embodiments thereof, the invention is not limited to these embodiments. It will be understood by those of ordinary skill in the art that various changes in form and details may be made therein without departing from the spirit and scope of the present invention as defined by the claims.

What is claimed is:

1. A broadband wireless access system comprising a terminal; and an access service network including a base station and a radio resources management node for managing radio resources of the base station,
wherein said base station comprises:
a resources examination requesting unit that, when said base station is requested by said terminal to perform any of the following operations including addition, creation and change of the service flow, inquires of said radio resources management node whether said base station has enough radio resources to perform the requested operation on the service flow; and
a terminal notification unit that, when said base station lacks the radio resources, notifies said terminal of a base station that is selected from among neighboring base stations by said radio resources management node as a performer base station for performing the requested operation on the service flow; and
said radio resources management node comprises:
a resources examination responding unit that, when the requested target base station lacks the radio resources, selects a base station having enough radio resources to perform the requested operation on the service flow from among the neighboring base stations as said performer base station.

2. The broadband wireless access system according to claim 1, wherein, when said base station has enough radio resources to perform the requested operation on the service flow, said terminal notification unit notifies said terminal that said base station will accept the service flow operation request.

3. The broadband wireless access system according to claim 2, wherein said terminal performs a network entry operation through said performer base station, and then also requests said performer base station to perform any of the following operations including the addition, creation and change of the service flow.

4. A base station provided in an access service network of a broadband wireless access system, comprising:
a resources examination requesting unit that, when said base station is requested by a terminal to perform any of the following operations including addition, creation and change of the service flow, inquires of a radio resources management node whether the base station has enough radio resources to perform the requested operation on the service flow; and
a terminal notification unit that, when the base station lacks the radio resources, notifies the terminal of a base station that is selected from among neighboring base stations by the radio resources management node as a performer base station for performing the requested operation on the service flow.

5. The base station according to claim 4, wherein, when the base station has enough radio resources to perform the requested operation on the service flow, said terminal notification unit notifies the terminal that the base station will accept the service flow operation request.

6. A notification method by a base station provided in an access service network of a broadband wireless access system, comprising:
inquiring of a radio resources management node whether the base station has enough radio resources to perform a requested operation on a service flow, when any of the following operations including addition, creation and change of the service flow is requested by a terminal; and
notifying the terminal of a base station that is selected from among neighboring base stations by the radio resources management node as a performer base station for performing the requested operation on the service flow, when the base station lacks the radio resources.

7. The notification method according to claim 6, further comprising notifying the terminal that the base station will accept the service flow operation request when the base station has enough radio resources to perform the requested operation on the service flow.
